(19) United States
(12) Patent Application Publication
(10) Pub. No.: US 2020/0269421 A1
(43) Pub. Date: Aug. 27, 2020

(54) INFORMATION PROCESSING DEVICE, INFORMATION PROCESSING METHOD, AND PROGRAM

(71) Applicant: Sony Corporation, Tokyo (JP)

(72) Inventors: Yuichiro KOYAMA, Tokyo (JP); Takeaki SHIMOE, Tokyo (JP); Ichitaro KOHARA, Kanagawa (JP)

(73) Assignee: Sony Corporation, Tokyo (JP)

(21) Appl. No.: 16/755,617

(22) PCT Filed: Aug. 1, 2018
(86) PCT No.: PCT/JP2018/028920

§ 371 Date: Apr. 13, 2020

(30) Foreign Application Priority Data
Oct. 30, 2017 (JP) 2017-209311

(51) Int. Cl. B25J 9/16; G06F 3/01; G06F 9/54; G10L 15/00; G10L 25/48

(52) U.S. Cl. CPC B25J 9/1664; B25J 9/1694; G10L 25/48; G06F 9/542; G10L 15/00; G06F 3/017

(57) ABSTRACT

The present technology is directed to performing feedback related to execution of recognition processing with a more natural motion.

Provided is an information processing device including a motion control unit that performs motion control of a moving object that acts on the basis of recognition processing, in which the motion control unit causes the moving object to execute a responding motion on the basis of input of recognition target information, and the responding motion is implicit feedback related to execution of the recognition processing. Furthermore, provided is an information processing method including performing, by a processor, motion control of a moving object that acts on the basis of recognition processing, in which performing the motion control further includes causing the moving object to execute a responding motion on the basis of input of recognition target information, and the responding motion is implicit feedback related to execution of the recognition processing.

### TECHNICAL FIELD

The present disclosure relates to an information processing device, an information processing method, and a program.

### BACKGROUND ART

In recent years, various kinds of devices that make motions based on recognition processing have been developed. The device described above includes a moving object such as a robot that performs autonomous actions on the basis of a recognized situation. For example, Patent Document 1 discloses a legged mobile robot that performs an autonomous motion and exhibits a feeling according to each situation.

### CITATION LIST

### Patent Document

Patent Document 1: Japanese Patent Application Laid-Open No. 2003-71763

### SUMMARY OF THE INVENTION

### Problems to be Solved by the Invention

By the way, in a device that makes motions based on recognition processing, it is important to present, to a user, a fact that recognition processing is being executed. However, in a case of performing feedback using a lamp like a legged mobile robot described in Patent Document 1, there may be an assumed case where unnatural expression is exhibited contrary to an aim of a moving object.

Considering this, the present disclosure proposes an information processing device, an information processing method, and a program which are novel, improved, and capable of performing feedback related to execution of recognition processing with a more natural motion.

### Solutions to Problems

According to the present disclosure, provided is an information processing device including a motion control unit that performs motion control of a moving object that acts on the basis of recognition processing, in which the motion control unit causes the moving object to execute a responding motion on the basis of input of recognition target information, and the responding motion is implicit feedback related to execution of the recognition processing.

Furthermore, according to the present disclosure, provided is an information processing method including performing, by a processor, motion control of a moving object that acts on the basis of recognition processing, in which performing the motion control includes causing the moving object to execute a responding motion on the basis of input of recognition target information, and the responding motion is implicit feedback related to execution of the recognition processing.

Moreover, according to the present disclosure, provided is a program causing a computer to function as an information processing device including a motion control unit that performs motion control of a moving object that acts on the basis of recognition processing, in which the motion control unit causes the moving object to execute a responding motion on the basis of input of recognition target information, and the responding motion is implicit feedback related to execution of the recognition processing.

### Effects of the Invention

As described above, according to the present disclosure, the feedback related to execution of the recognition processing can be performed with a more natural motion.

Note that the above-described effect is not constantly limited, and any one of effects described in the present specification or other effects that can be grasped from the present specification may also be provided in addition to the above-described effect or instead of the above-described effect.

### BRIEF DESCRIPTION OF DRAWINGS

FIG. 1 is a view illustrating an exemplary hardware configuration of an autonomous mobile object according to an embodiment of the present disclosure.

FIG. 2 illustrates an exemplary configuration of an actuator included in the autonomous mobile object according to the embodiment of the present disclosure.

FIG. 3 is a view to describe motions of the actuator included in the autonomous mobile object according to the embodiment of the present disclosure.

FIG. 4 is a view to describe motions of the actuator included in the autonomous mobile object according to the embodiment of the present disclosure.

FIG. 5 is a view to describe a function of a display included in the autonomous mobile object according to the embodiment of the present disclosure.

FIG. 6 is a view illustrating exemplary motions of the autonomous mobile object according to the embodiment of the present disclosure.

FIG. 7 is a functional block diagram illustrating exemplary functional configurations of an autonomous mobile object 10 according to the first embodiment of the present disclosure.

FIG. 8 is a view illustrating exemplary motion control according to a comparison technique according to the embodiment.

FIG. 9 is a view illustrating an outline of motion control according to the embodiment.

FIG. 10 is a diagram to describe a difference between an information processing method and the comparison technique according to the embodiment.

FIG. 11 is a view illustrating an exemplary first response according to the embodiment.

FIG. 12 is a view illustrating an exemplary second response according to the embodiment.

FIG. 13 is a view illustrating an exemplary third response according to the embodiment.

FIG. 14 is a view to describe dynamic control of a motion category based on a situation according to the embodiment.

FIG. 15 is a view to describe motion control based on recognition of an addressee of an utterance according to the embodiment.

FIG. 16 is a view to describe transition control to a responding motion according to the embodiment.

FIG. 17 is a view to describe control of a moving object in a virtual space according to the embodiment.

FIG. 18 is a flowchart illustrating a flow of the motion control according to the embodiment.

FIG. 19 is a diagram illustrating an exemplary hardware configuration of a motion control device according to an embodiment of the present disclosure.

### MODE FOR CARRYING OUT THE INVENTION

Hereinafter, preferred embodiments of the present disclosure will be described in detail with reference to the accompanying drawings. Note that, in the present specification and the drawings, a constituent element having substantially the same functional configuration will be denoted by the same reference sign, and repetition of the same description will be omitted.

Note that the description will be provided in the following order.

1. Outline of Autonomous Mobile Object 10

2. Exemplary Hardware Configuration of Autonomous Mobile Object 10

3. First Embodiment
3.1. Outline
3.2. Exemplary Functional Configurations
3.3. Specific Examples of Motion Control
3.4. Flow of Control

4. Exemplary Hardware Configuration of Motion Control Device

5. Conclusion

<1. Outline of Autonomous Mobile Object 10>

First, an outline of an autonomous mobile object 10 according to an embodiment of the present disclosure will be described. The autonomous mobile object 10 according to the embodiment of the present disclosure includes an information processing device that executes situational estimation based on collected sensor information and autonomously selects and executes various kinds of motions according to each situation. One of the features of the autonomous mobile object 10 is that a motion that has been estimated as optimal is autonomously executed in each situation, which is different from a robot that simply performs a motion in accordance with an instructional command of a user.

Therefore, depending on a situation, there may be a case where the autonomous mobile object 10 according to the embodiment of the present disclosure does not execute, on purpose, a motion in response to an instruction of a user, and also there may be a case where the autonomous mobile object executes another behavior different from the motion. Examples of the above-described situation correspond to, for example: a case of executing a motion in response to the instruction of the user; a case where safety of the user, the autonomous mobile object 10, or a peripheral environment is compromised; a case where the autonomous mobile object 10 prioritizes another desire (instinct) of electric charge processing or the like; and the like.

Furthermore, there may be a case where the autonomous mobile object 10 attempts to induce an interest of the user or attempts to transmit own feelings and a hardware state to the user by not following the instruction of the user on purpose.

On the other hand, the autonomous mobile object 10 has a strong desire (instinct) to be loved by the user. Therefore, the autonomous mobile object 10 repeatedly executes a motion in response to an instruction of the user in order to please the user, learns a favorite motion of the user, and spontaneously executes such a motion even in a case where no instruction is given.

Thus, the autonomous mobile object 10 according to the embodiment of the present disclosure comprehensively evaluates a desire, a feeling, a peripheral environment, and the like, and then determines and executes an autonomous motion like animals including a human. In the above-described points, the autonomous mobile object 10 is obviously different from a passive device that executes a corresponding motion or corresponding processing on the basis of an instruction.

The autonomous mobile object 10 according to the embodiment of the present disclosure may be an autonomous mobile robot that autonomously moves in a space and executes various kinds of motions. The autonomous mobile object 10 may be the autonomous mobile robot that has a shape replicating, for example, a human or an animal such as a dog and has ability to make motions. Furthermore, the autonomous mobile object 10 may be a vehicle or another device that has ability to communicate with a user, for example. The shape, the ability, and a level of desire or the like of the autonomous mobile object 10 according to the embodiment of the present disclosure can be designed as appropriate in accordance with a purpose and a role.

<2. Exemplary Hardware Configuration of Autonomous Mobile Object 10>

Next, an exemplary hardware configuration of the autonomous mobile object 10 according to the embodiment of the present disclosure will be described. Note that a case where the autonomous mobile object 10 is a dog-shaped quadrupedal walking robot will be described below as an example.

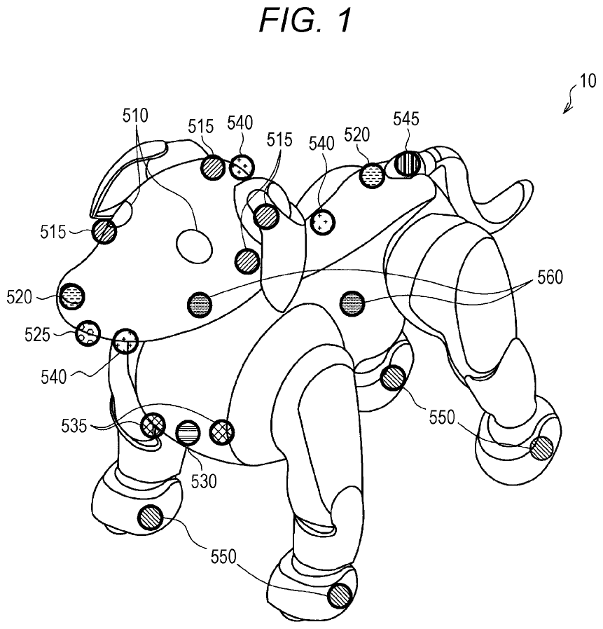

FIG. 1 is a view illustrating the exemplary hardware configuration of the autonomous mobile object 10 according to the embodiment of the present disclosure. As illustrated in FIG. 1, the autonomous mobile object 10 is the dog-shaped quadrupedal walking robot having a head, a trunk, four legs, and a tail. Furthermore, the autonomous mobile object 10 includes two displays 510 on the head.

Furthermore, the autonomous mobile object 10 includes various kinds of sensors. The autonomous mobile object 10 includes, for example, a microphone 515, a camera 520, a time-of-flight (ToF) sensor 525, a human sensor 530, a distance sensor 535, a touch sensor 540, an illuminance sensor 545, a foot sole button 550, and an inertial sensor 555.

(Microphone 515)

The microphone 515 has a function of collecting peripheral sounds. The sounds described above include, for example, an utterance of a user and peripheral environmental sounds. The autonomous mobile object 10 may include, for example, four microphones on the head. Since the plurality of microphones 515 is provided, sounds generated in the periphery can be collected with high sensitivity and also sound source localization can be performed.

(Camera 520)

The camera 520 has a function of imaging a user and a peripheral environment. The autonomous mobile object 10 may also include, for example, two wide-angle cameras at a nose tip and a waist. In this case, the wide-angle camera arranged at the nose tip captures an image corresponding to a front field of view of the autonomous mobile object (i.e., a field of view of the dog), and the wide-angle camera at the waist captures an image of a peripheral area mainly on an upper side thereof. The autonomous mobile object 10 can extract, for example, a feature point of a ceiling on the basis of an image captured by the wide-angle camera arranged on the waist and can implement simultaneous localization and mapping (SLAM).

(ToF Sensor 525)

The ToF sensor 525 has a function of detecting a distance from an object existing in front of the head. The ToF sensor 525 is provided at the nose tip of the head. According to the ToF sensor 525, distances from various objects can be detected with high accuracy, and a motion according to a relative position to a target including a user, an obstacle, or the like can be performed.

(Human Sensor 530)

The human sensor 530 has a function of detecting presence of a user, a pet raised by the user, or the like. The human sensor 530 is arranged on a chest, for example. According to the human sensor 530, an animal body existing in front is detected, and as a result, various kinds of motions to the animal body, for example, motions according to feelings such as interest, fear, surprise, and the like can be performed.

(Distance Sensor 535)

The distance sensor 535 has a function of acquiring a situation of a front floor surface of the autonomous mobile object 10. The distance sensor 535 is arranged on the chest, for example. According to the distance sensor 535, a distance between the autonomous mobile object 10 and an object existing on the front floor surface can be detected with high accuracy, and a motion according to a relative position with the object can be performed.

(Touch Sensor 540)

The touch sensor 540 has a function of detecting a contact by a user. The touch sensor 540 is arranged at regions of the autonomous mobile object 10, for example, a head top, under the chin, the back, and the like which may be touched by the user with high possibility. The touch sensor 540 may be, for example, a capacitance type touch sensor or pressure-sensitive type touch sensor. According to the touch sensor 540, a contacting act such as touching, patting, hitting, pushing, or the like by the user can be detected, and a motion in response to the contacting act can be performed.

(Illuminance Sensor 545)

The illuminance sensor 545 detects illuminance of a space where the autonomous mobile object 10 is positioned. For example, the illuminance sensor 545 may be arranged at a base of the tail or the like behind the head. According to the illuminance sensor 545, peripheral brightness can be detected, and a motion according to the brightness can be executed.

(Foot Sole Button 550)

The foot sole button 550 has a function of detecting whether or not a bottom surface of a leg of the autonomous mobile object 10 is in contact with the floor. To achieve this, the foot sole button 550 is arranged at a region corresponding to each of paws of the four legs. According to the foot sole button 550, a contact state or non-contact state between the autonomous mobile object 10 and the floor surface can be detected, and for example, it is possible to grasp that the autonomous mobile object 10 is picked up and held by a user.

(Inertial Sensor 555)

The inertial sensor 555 is a six-axial sensor that detects physical quantities such as velocity, acceleration, and rotation in each of the head and the trunk. That is, the inertial sensor 555 detects the acceleration and angular velocity in each of an X axis, a Y axis, and a Z axis. The inertial sensor 555 is arranged in each of the head and the trunk. According to the inertial sensors 555, movement of the head and the trunk of the autonomous mobile object 10 can be detected with high accuracy, and motion control according to each situation can be performed.

In the above, the exemplary sensors included in the autonomous mobile object 10 according to the embodiment of the present disclosure have been described. Note that the configurations described above with reference to FIG. 1 are merely examples, and the configurations of the sensors that can be included in the autonomous mobile object 10 are not limited thereto. Besides the configurations described above, the autonomous mobile object 10 may further include, for example, various kinds of communication devices including a temperature sensor, a geomagnetic sensor, and a global navigation satellite system (GNSS) signal receiver, and the like. The configurations of the sensors included in the autonomous mobile object 10 can be flexibly modified in accordance with specifications and each practical application.

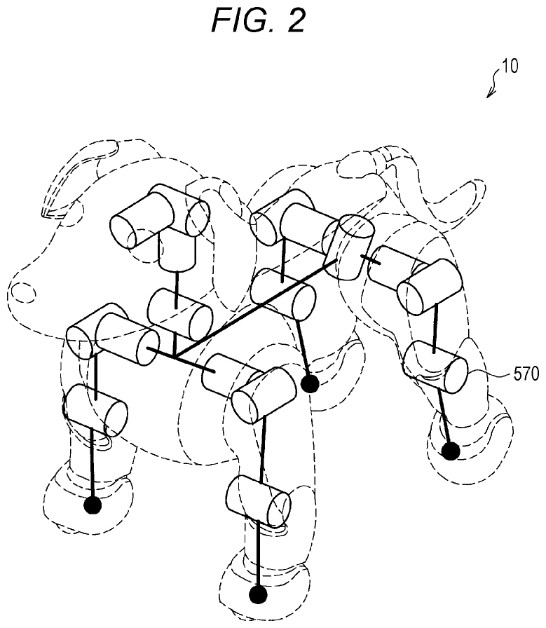

Subsequently, an exemplary configuration of joint portions of the autonomous mobile object 10 according to the embodiment of the present disclosure will be described. FIG. 2 is an exemplary configuration of actuators 570 included in the autonomous mobile object 10 according to the embodiment of the present disclosure. The autonomous mobile object 10 according to the embodiment of the present disclosure includes twenty-two rotational degrees of freedom in total including: two in each of ears and the tail, and one in the mouth in addition to rotating parts illustrated in FIG. 2.

For example, the autonomous mobile object 10 includes three degrees of freedom at the head, and therefore, two motions of nodding and tilting the head can be performed at the same time. Furthermore, the autonomous mobile object 10 reproduces a waist swing motion by the actuator 570 provided at the waist, and can perform natural and flexible motions closer to a real dog.

Note that the autonomous mobile object 10 according to the embodiment of the present disclosure may implement the twenty-two rotational degrees of freedom described above by, for example, combining a one-axial actuator with a two-axial actuator. For example, the one-axial actuators may be employed at elbows and knees of the legs, and the two-axial actuators may be employed at shoulders and bases of thighs, respectively.

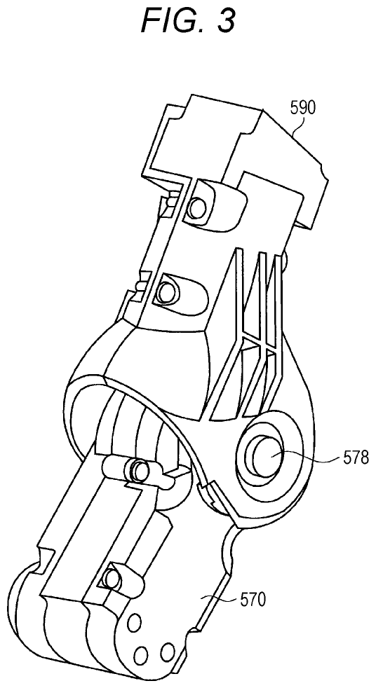

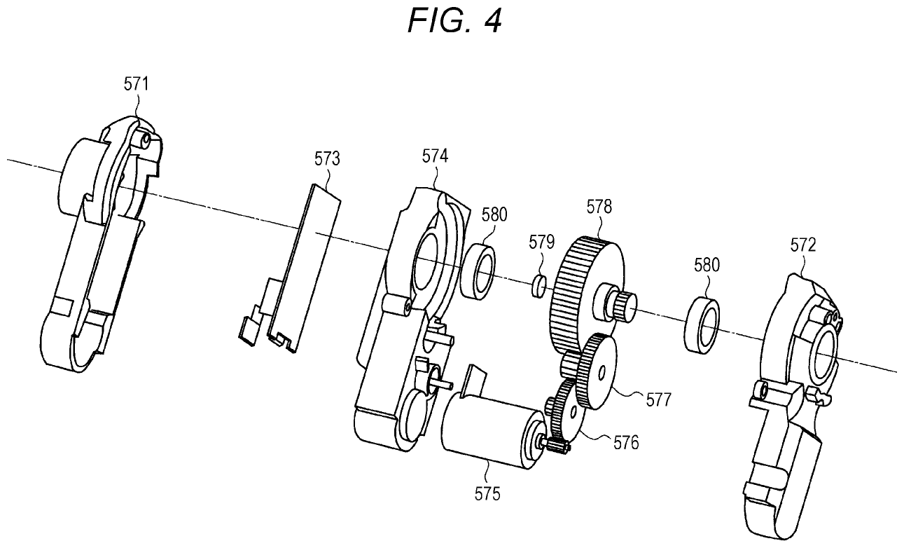

FIGS. 3 and 4 are views to describe motions of an actuator 570 included in the autonomous mobile object 10 according to the embodiment of the present disclosure. Referring to FIG. 3, the actuator 570 can drive a movable arm 590 at an arbitrary rotational position and a rotational speed by rotating an output gear with a motor 575.

Referring to FIG. 4, the actuator 570 according to the embodiment of the present disclosure includes a rear cover 571, a gearbox cover 572, a control board 573, a gearbox base 574, the motor 575, a first gear 576, a second gear 577, and an output gear 578, a detection magnet 579, and two bearings 580.

The actuator 570 according to the embodiment of the present disclosure may be, for example, a magnetic spin-valve giant magnetoresistive (svGMR). When the control board 573 rotates the motor 575 on the basis of control by a main processor, power is transmitted to the output gear 578 via the first gear 576 and the second gear 577, and the movable arm 590 can be driven.

Furthermore, when a position sensor provided on the control board 573 detects a rotary angle of the detection magnet 579 that is rotated in synchronization with the output gear 578, a rotational angle of the movable arm 590, that is, the rotational position can be detected with high accuracy.

Note that, since the magnetic svGMR is a non-contact type, the magnetic svGMR has excellent durability, and when the magnetic svGMR is used in a GMR saturation area, there is an advantage of receiving little influence of signal fluctuation caused by distance fluctuation of the detection magnet 579 or the position sensor.

In the above, the exemplary configuration of the actuator 570 included in the autonomous mobile object 10 according to the embodiment of the present disclosure has been described. According to the above-described configuration, it is possible to: control bending and stretching motions of the joint portions included in the autonomous mobile object 10 with high accuracy; and also accurately detect a rotational position of each of the joint positions.

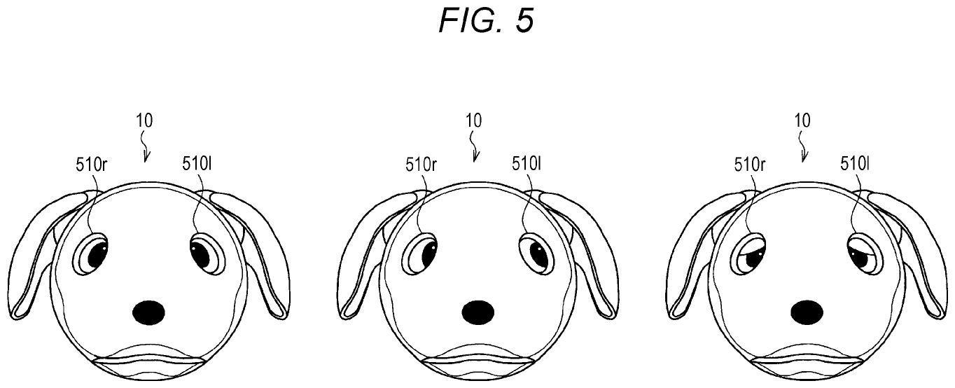

Subsequently, a function of the display 510 included in the autonomous mobile object 10 according to the embodiment of the present disclosure will be described with reference to FIG. 5. FIG. 5 is a view to describe the function of the display 510 included in the autonomous mobile object 10 according to the embodiment of the present disclosure.

(Display 510)

The displays 510 each have a function of visually expressing eye movements and feelings of the autonomous mobile object 10. As illustrated in FIG. 5, the displays 510 can express motions of eyeballs, pupils, and eyelids according to a feeling and a motion. The displays 510 produce natural motions close to a real animal such as a dog by not displaying, on purpose, a character, a symbol, an image, and the like not associated with eyeball movements.

Furthermore, as illustrated in FIG. 5, the autonomous mobile object 10 includes two displays 510r and 510l corresponding to a right eye and a left eye, respectively. The displays 510r and 510l are implemented by, for example, two independent organic light emitting diodes (OLEDs). According to the OLEDs, curved surfaces of eyeballs can be reproduced, and a more natural exterior can be implemented as compared to a case where a pair of eyeballs is presented by a single flat display or a case where two eyeballs are presented by two independent flat displays.

As described above, according to the displays 510r and 510l, a line-of-sight and feelings of the autonomous mobile object 10 as illustrated in FIG. 5 can be expressed with high accuracy and flexibility. Furthermore, a user can intuitively grasp a state of the autonomous mobile object 10 from motions of the eyeballs displayed on the displays 510.

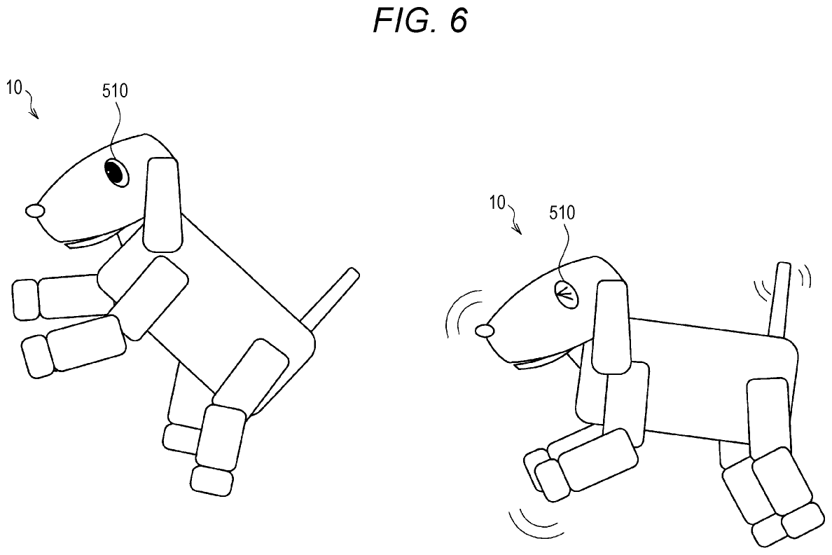

In the above, the exemplary hardware configuration of the autonomous mobile object 10 according to the embodiment of the present disclosure has been described. According to the above-described configuration, since the motions of the joint portions and the eyeballs of the autonomous mobile object 10 can be flexibly controlled with high accuracy as illustrated in FIG. 6, the motions closer to a real living being and the expression of the feelings can be achieved. Note that FIG. 6 is a view illustrating exemplary motions of the autonomous mobile object 10 according to the embodiment of the present disclosure, but in FIG. 6, an external structure of the autonomous mobile object 10 is simply illustrated because the description will be provided focusing on the motions of the joint portions and the eyeballs of the autonomous mobile object 10. The hardware configuration and the exterior of the autonomous mobile object 10 according to the embodiment of the present disclosure are not limited to the examples illustrated in the drawings and may be designed as appropriate.

<3. First Embodiment>

<<3.1 Outline>>

Next, a first embodiment of the present disclosure will be described. As described above, an autonomous mobile object 10 (also referred to as the moving object) according to the embodiment of the present disclosure may be a dog-shaped information processing device. One of features of the autonomous mobile object 10 according to the embodiment of the present disclosure is not including an output means for visual information excluding feeling expression by eyeball movements or a linguistic communication means using voice. According to this feature, a more natural motion close to an actual dog can be performed, and a user feels less strangeness about the function and exterior of the autonomous mobile object 10.

However, in a case of a device not including an explicit information transmission means for a user like the autonomous mobile object 10, there may be a case where the user has difficulty in clearly grasping a state of the device. For example, the autonomous mobile object 10 has a function of recognizing an utterance of the user and executing an action based on a result of the recognition. However, unlike a voice recognition function mounted on a smartphone or the like, the user does not provide any explicit instruction to start the recognition with a button or the like in the voice recognition by the autonomous mobile object 10. Therefore, it is difficult for the user to determine whether or not the recognition processing is executed until an action based on a recognition result is exhibited.

Moreover, as described above, depending on a situation, there is a case where the autonomous mobile object 10 according to the embodiment of the present disclosure may not execute, on purpose, a motion in response to an instruction of a user or a case where the autonomous mobile object may execute another behavior different from the action. Therefore, in a case where the recognition processing is executed normally and the autonomous mobile object 10 performs an action not conforming to an intention of the user, there is an assumed possibility that the user may misidentify that the recognition processing has failed or the recognition processing has not been performed.

On the other hand, to eliminate the possibility as described above, it may be conceivable to explicitly perform feedback related to the execution of the recognition processing by outputting words, for example, “recognition is being executed” or the like with voice or visual information or by turning on a lamp, for example.

However, as described above, the explicit feedback as described above may make the behavior of the autonomous mobile object 10 unnatural and may reduce interest or enthusiasm of the user with respect to the autonomous mobile object 10.

The technical idea according to the present embodiment is devised focusing on the above-described points, and enables performance of more natural feedback related to the execution of the recognition processing. To achieve this, the autonomous mobile object 10 that implements an information processing method according to the present embodiment has one of the features of executing, on the basis of input of recognition target information, a responding motion that is implicit feedback related to the execution of the recognition processing.

Hereinafter, the above-described features of the autonomous mobile object 10 according to the present embodiment and effects provided by the features will be described in detail.

<<3.2. Functional Exemplary Configurations>>

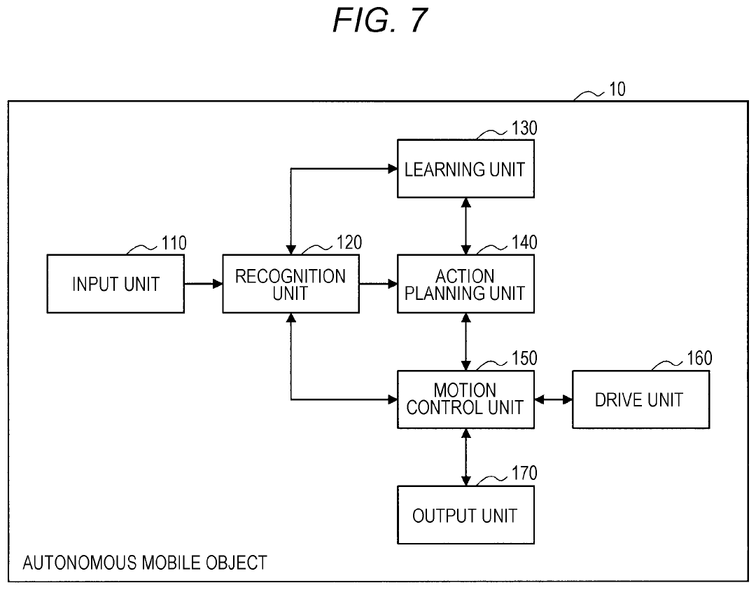

First, functional exemplary configurations of the autonomous mobile object 10 according to the present embodiment will be described. FIG. 7 is a functional block diagram illustrating the functional exemplary configurations of the autonomous mobile object 10 according to the present embodiment. Referring to FIG. 7, the autonomous mobile object 10 according to the present embodiment includes an input unit 110, a recognition unit 120, a learning unit 130, an action planning unit 140, a motion control unit 150, a drive unit 160, and an output unit 170.

(Input Unit 110)

The input unit 110 has a function of collecting various kinds of information related to a user and a peripheral environment. The input unit 110 collects, for example, utterances of the user and environmental sounds generated in a periphery, image information related to the user and the peripheral environment, and various kinds of sensor information. To achieve this, the input unit 110 includes various kinds of sensors illustrated in FIG. 1.

(Recognition Unit 120)

The recognition unit 120 has a function of performing various kinds of recognition related to the user, the peripheral environment, and a state of the autonomous mobile object 10 on the basis of the various kinds of information collected by the input unit 110. As an example, the recognition unit 120 may perform human identification, recognition of face expression and a line-of-sight, object recognition, color recognition, shape recognition, marker recognition, obstacle recognition, level difference recognition, brightness recognition, and the like.

Furthermore, the recognition unit 120 performs voice recognition based on an utterance of the user, word comprehension, feeling recognition, sound source localization, and the like. Additionally, the recognition unit 120 can recognize contact by the user and the like, a peripheral temperature, existence of an animal body, posture of the autonomous mobile object 10, and the like.

Moreover, the recognition unit 120 has functions of estimating and comprehending, on the basis of the above-described recognized information, a peripheral environment and a situation where the autonomous mobile object 10 is placed. At this time, the recognition unit 120 may also integrally estimate a situation by using environmental knowledge stored in advance.

(Learning Unit 130)

The learning unit 130 has a function of learning environments (situations), actions, and interactions to the environments by the actions. The learning unit 130 achieves the above-described learning by using, for example, a machine learning algorithm such as deep learning. Note that the learning algorithm employed by the learning unit 130 is not limited to the above-described example, and can be designed as appropriate.

(Action Planning Unit 140)

The action planning unit 140 has a function of planning an action to be performed by the autonomous mobile object 10 on the basis of a situation estimated by the recognition unit 120 and the knowledge learned by the learning unit 130. For example, the action planning unit 140 according to the present embodiment determines, on the basis of an utterance of a user recognized by the recognition unit 120, execution of an action conforming to an intention of the utterance of the user or an action not following the intention of the utterance of the user on purpose.

(Motion Control Unit 150)

The motion control unit 150 has a function of controlling operation of the drive unit 160 and operation of the output unit 170 on the basis of the recognition processing by the recognition unit 120 and the action plan by the action planning unit 140. The motion control unit 150 performs, for example, rotation control of the actuators 570, display control of each display 510, control of sound output by a speaker, and the like on the basis of the action plan described above.

Furthermore, the motion control unit 150 according to the present embodiment has one of features of performing control, on the basis of input of the recognition target information, execution of a responding motion that is implicit feedback related to the execution of the recognition processing. Details of the function of the motion control unit 150 according to the present embodiment will be described in detail separately.

(Drive Unit 160)

The drive unit 160 has a function of bending and stretching a plurality of joint portions included in the autonomous mobile object 10 on the basis of the control by the motion control unit 150. More specifically, the drive unit 160 drives an actuator 570 included in each joint portion on the basis of the control by the motion control unit 150.

(Output Unit 170)

The output unit 170 has a function of outputting visual information and sound information on the basis of the control by the motion control unit 150. To achieve this, the output unit 170 includes the displays 510 and the speaker. Note that the output unit 170 according to the present embodiment has one of features of not outputting explicit linguistic communication information as described above.

In the above, the functional configurations of the autonomous mobile object 10 according to the present embodiment have been described. Note that the configurations illustrated in FIG. 7 are merely examples, and the functional configurations of the autonomous mobile object 10 according to the present embodiment are not limited to the examples. The autonomous mobile object 10 according to the present embodiment may include, for example, a communication unit that communicates with an information processing server and another autonomous mobile object and the like.

Furthermore, the recognition unit 120, the learning unit 130, the action planning unit 140, the motion control unit 150, and the like according to the present embodiment may be implemented as functions of the information processing server (motion control device) described above. In this case, the motion control unit 150 can control the drive unit 160 and the output unit 170 of the autonomous mobile object 10 on the basis of the action plan determined on the basis of the sensor information collected by the input unit 110 of the autonomous mobile object 10. The functional configuration of the autonomous mobile object 10 according to the present embodiment can be flexibly modified in accordance with specifications and each practical application.

<<3.3. Specific Examples of Motion Control>>

Subsequently, specific examples of motion control according to the present embodiment will be described in detail. As described above, the motion control unit 150 according to the present embodiment has the one of the features of controlling, on the basis of the input of the recognition target information, execution of a responding motion that is implicit feedback related to the execution of the recognition processing. According to this feature, a user can intuitively grasp progress of the recognition processing by the autonomous mobile object 10.

Note that the function of the motion control unit 150 will be described below using an exemplary case where the autonomous mobile object 10 according to the present embodiment executes voice recognition. However, the recognition processing according to the present embodiment is not limited to this example, and the technical idea according to the present embodiment can be applied to various kinds of recognition processing and estimation processing. The motion control unit 150 according to the present embodiment can control, for example, implicit feedback related to object recognition, speaker recognition or voiceprint recognition, marker recognition, feeling estimation, and the like.

Here, a description will be first provided for motion control by a comparison technique relative to the information processing method according to the present embodiment. As described above, there may be a case where the autonomous mobile object 10 performs an action not conforming to an intention of the user even in a case where the autonomous mobile object 10 correctly recognizes an utterance of a user. In such a case, it is difficult for the user to determine whether or not the voice recognition has been executed, and there is a possibility that the user misidentifies the action as malfunction of the autonomous mobile object.

To eliminate the possibility described above, it is also assumed to perform feedback that indicates completion of the voice recognition separately from the action based on the recognition.

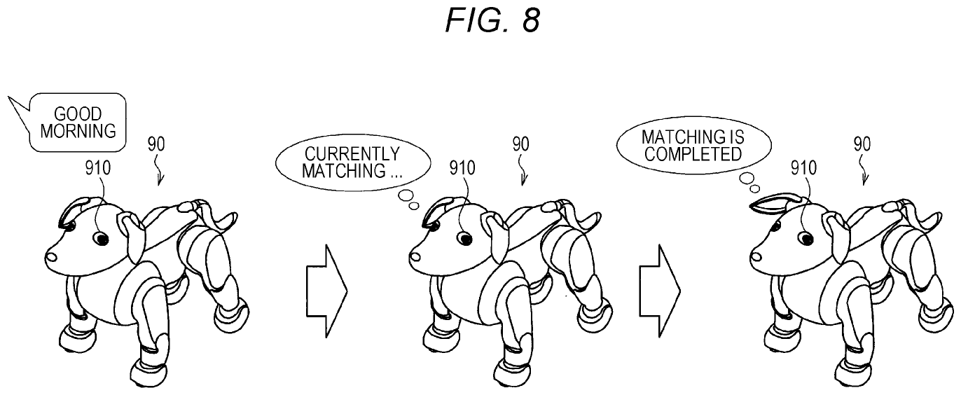

FIG. 8 is a view illustrating exemplary motion control by the comparison technique. FIG. 8 illustrates state changes in time series when a moving object 90 according to the comparison technique executes voice recognition processing related to an utterance of a user.

Note that, in the present embodiment, the voice recognition processing is implemented by signal processing, utterance detection, pattern recognition, and utterance comprehension, and the utterance comprehension will be described using an exemplary case of employing dictionary matching with an acquired pattern. However, the above-described case is merely an example, and the information processing method according to the present embodiment can be applied to various kinds of voice recognition techniques.

The left side of FIG. 8, the center of FIG. 8, and the right side of FIG. 8 illustrate a state of the moving object 90 at the time of detecting start of an utterance of a user, a state of the moving object 90 at the time of detecting an end of the utterance of the user and starting the matching, and a state of the moving object 90 at the time of completing the matching, respectively.

As illustrated, in the comparison technique, when the matching is completed, a fact that the voice recognition processing is completed is fed back to the user by causing the moving object 90 to execute a motion of moving an ear. According to this control, even in a case where the moving object 90 performs an action not conforming to the intention thereafter, the user can grasp that the voice recognition processing has been executed.

However, it is difficult for the user to grasp that the voice recognition processing has been started or is currently executed until the user confirms the movement of the ear at the time of completion of the matching.

Considering this, the motion control unit 150 according to the present embodiment solves the above-describe point by: causing the autonomous mobile object 10 to execute a first response on the basis of a fact of detecting start of input of recognition target information; and causing the autonomous mobile object 10 to execute a second response on the basis of a fact of detecting end of the input of the recognition target information. Note that the above-described recognition target information represents an utterance of a user in the case of the present example.

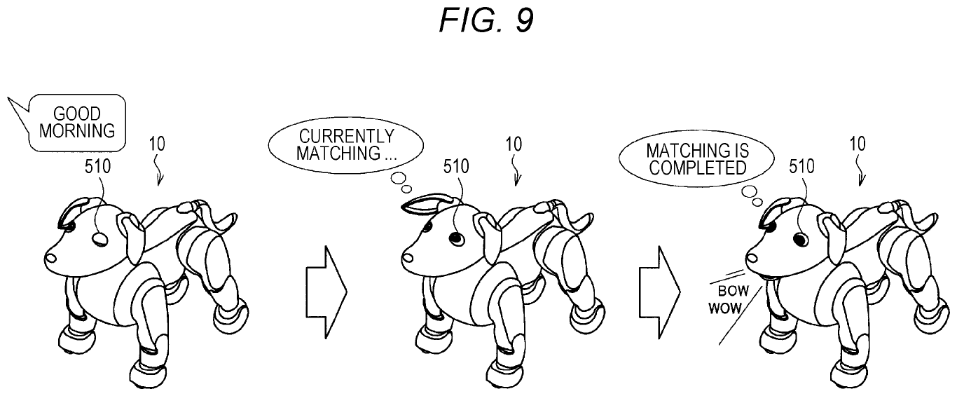

FIG. 9 is a view illustrating an outline of the motion control according to the present embodiment. Similar to FIG. 8, FIG. 9 illustrates states of the autonomous mobile object 10 in time series at the time of detecting start of an utterance, at the time of detecting completion of the utterance, and at the time of completion of the matching.

First, the motion control unit 150 according to the present embodiment may cause the output unit 170 to execute the first response using an eyeball motion when the start of the utterance is detected by the recognition unit 120. The above-described eyeball motion is implemented by each display 510. According to the first response, the user can grasp, with less delay, that the autonomous mobile object 10 has reacted to the utterance of the user. Furthermore, according to the first response, silent feedback can be made to the user, and it is possible to effectively prevent degradation of accuracy of the voice recognition caused by a driving sound of the actuator 570 or a sound output from the speaker. Thus, the implicit feedback by the output of the visual information related to the eyeball motion provides a high effect on a voice recognition device including a drive unit.

Next, when the end of the utterance is detected by the recognition unit 120 and the matching is started, the motion control unit 150 may cause the drive unit 160 to execute a motion of raising an ear. According to the second response, the autonomous mobile object 10 can produce motions of reacting to the utterance of the user and bending an ear, and the user can intuitively grasp that the voice recognition processing is being executed.

Furthermore, the motion control unit 150 according to the present embodiment causes the autonomous mobile object 10 to execute a third response that is feedback indicating completion of the recognition processing on the basis of the fact that the matching, that is, the recognition processing is completed. For example, the motion control unit 150 may cause the drive unit 160 to execute a motion of lowering an ear and a motion of opening a mouth and may cause the output unit 170 to output a sound corresponding to barking.

According to the third response described above, the user can clearly grasp that the voice recognition processing has been executed. Note that the motion control unit 150 may cause the autonomous mobile object 10 to execute a motion corresponding to an action planned by the action planning unit 140 on the basis of a voice recognition result after the execution of the third response. Note that there may be a case where the above-described action is an action not conforming to an intention of the utterance of the user as described above.

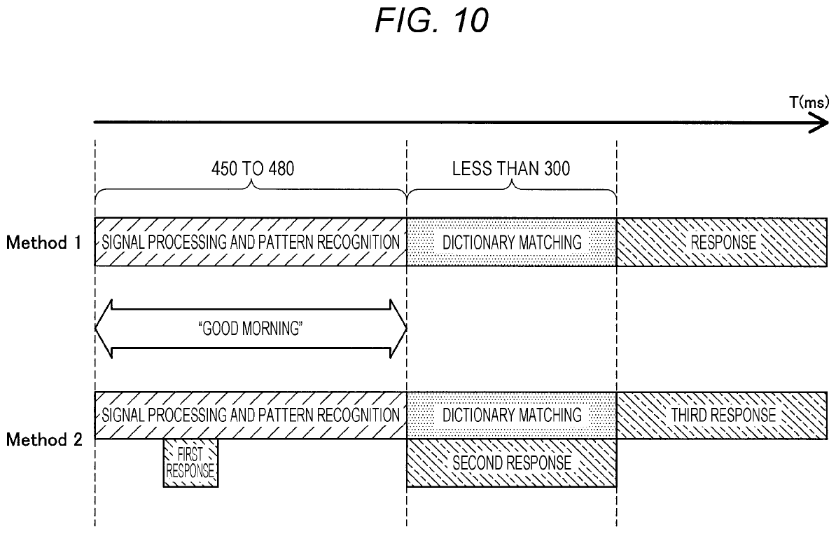

FIG. 10 is a diagram to describe differences in the voice recognition processing and the responding motions between the information processing method according to the present embodiment and the comparison technique. FIG. 10 illustrates, in time series, correspondence between the voice recognition processing and the responding motions in each of the information processing method according to the present embodiment and comparison technique. Note that Method 1 in the drawing corresponds to the above-described comparison technique and Method 2 corresponds to the information processing method according to the present embodiment.

Referring to FIG. 10, it is found that it takes about 800 ms in the comparison technique before a responding motion to a user is performed. Due to this, the user may feel strangeness about a fact that the moving object does not make any reaction for about 800 ms although the user can grasp that the processing has been executed by the responding motion indicating the completion of the voice recognition processing.

On the other hand, in the information processing method according to the present embodiment, the first response is made shortly after the user starts an utterance of “Good morning”, and the second response is executed without delay at the time of starting the matching accompanied by the detection of the end of the utterance. Thus, according to the information processing method according to the present embodiment, a plurality of levels of feedback can be stepwisely performed immediately after start of the utterance of the user. According to this technique, the user can grasp that the autonomous mobile object 10 is trying to understand the utterance of the user even in a stage before completing the matching.

Next, a specific example of the first response according to the present embodiment will be described in detail. As described above, the first response according to the present embodiment may include an eyeball motion.

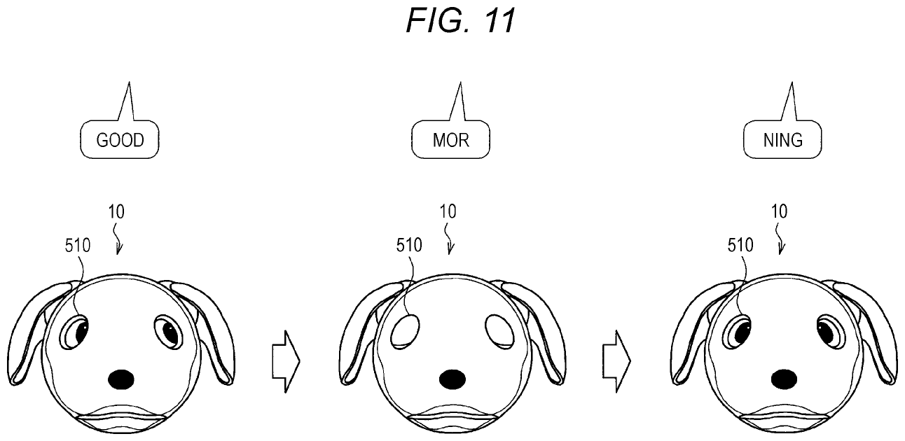

FIG. 11 is a view illustrating an exemplary first response according to the present embodiment. FIG. 1 illustrates changes in time series of the displays 510 controlled by the motion control unit 150. Specifically, in a case where start of an utterance of a user is detected by the recognition unit 120, the motion control unit 150 according to the present embodiment may display an image corresponding to blinking on each of the displays 510.

Note that the motion control unit 150 may cause each of the displays 510 to output expression of making eye contact with the user or expression of a wink or the like, besides the blinking as illustrated.

Thus, since the motion control unit 150 according to the present embodiment causes the output unit 170 to execute display related to an eyeball motion as the first response, feedback to the utterance of the user without less delay can be achieved without hindering the voice recognition processing.

Note that the motion control unit 150 according to the present embodiment may cause the autonomous mobile object 10 to execute, as the first response, a body motion accompanied by driving of the actuator 570 or an emotional expressive motion using a sound, besides the eyeball motion. Note that the above-described emotional expressive motion using a sound includes a wide range of non-verbal motions such as barking, feathering, clapping, and the like.

In this case, there is an assumed possibility that the accuracy of voice recognition is degraded by the driving sound of the actuator 570 or the sound output from the speaker, but for example, in a case where a positional relation between the speaker and the microphone is fixed, the degradation of the recognition accuracy can be suppressed by performing, for example, echo cancellation using a reference signal. Furthermore, there may be a situation in which convenience for a user is improved by not employing the eyeball motion as the first response as described later.

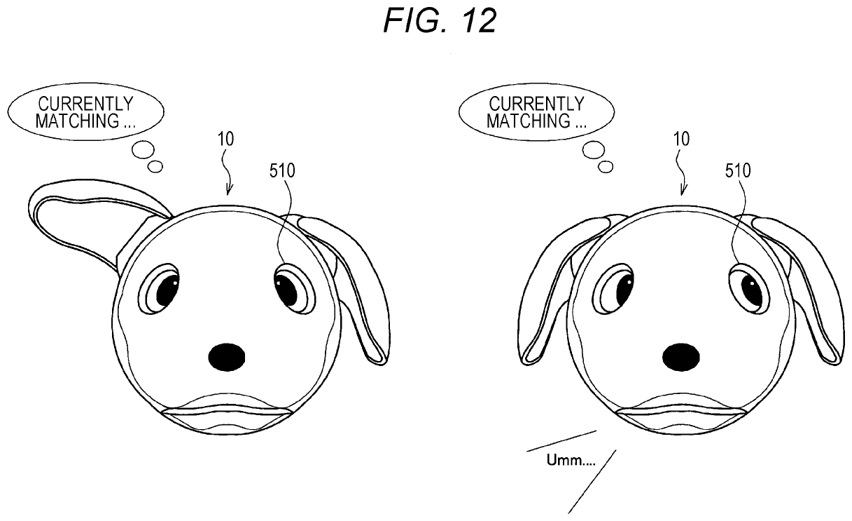

Next, a specific example of the second response according to the present embodiment will be described in detail. The second response according to the present embodiment may be any one of an eyeball motion, a body motion, or an emotional expressive motion using a sound, or a combination thereof. FIG. 12 is a view illustrating an exemplary second response according to the present embodiment.

For example, the motion control unit 150 according to the present embodiment may control a body motion such as raising an ear as illustrated on the left side of FIG. 12. Note that the motion control unit 150 may control a motion of the tail, a leg, or the like, besides the motion of the ear.

On the other hand, the motion control unit 150 may control the eyeball motion, for example, a motion of directing a line-of-sight obliquely above as illustrated on the right side of FIG. 12. Furthermore, the motion control unit 150 can also control the emotional expressive motion, for example, slightly growling or the like. As the second response according to the present embodiment, for example, it may be possible to employ a more natural motion according to a kind of the living being adopted as a model of the autonomous mobile object 10.

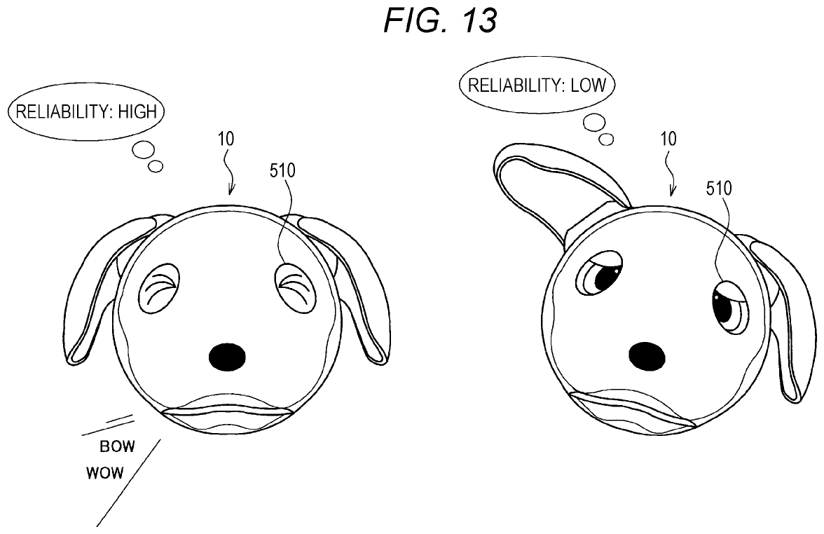

Next, a specific example of the third response according to the present embodiment will be described in detail. The third response according to the present embodiment may be any one of an eyeball motion, a body motion, or an emotional expressive motion using a sound, or a combination thereof. Furthermore, the motion control unit 150 according to the present embodiment can dynamically determine a motion of the third response on the basis of reliability related to the recognition processing. FIG. 13 is a view illustrating an exemplary third response according to the present embodiment.

In a case where the reliability related to the recognition processing is high, the motion control unit 150 according to the present embodiment causes the autonomous mobile object 10 to execute a positive third response indicating that an utterance of a user is comprehended as illustrated, for example, on the left side of FIG. 13. The above-described positive behavior includes emotional expressive motions corresponding to, for example, joy, excitement, interest, and the like.

On the other hand, in a case where the reliability related to the recognition processing is low, the motion control unit 150 according to the present embodiment causes the autonomous mobile object 10 to execute the third response, for example, to prompt a user to issue the utterance again as illustrated on the right side of FIG. 13. The third response to prompt the user to issue the utterance again includes emotional expressive motions corresponding to, for example, question, anxiety, and the like. For example, the motion control unit 150 may cause the drive unit 160 to execute a motion of raising an ear while tilting the head.

According to the above-described function of the motion control unit 150, the user can intuitively grasp that a result of the voice recognition processing is not good, and the user can issue the utterance again.

In the above, the first response, the second response, and the third response according to the present embodiment have been described with the specific examples. As described above, the first response, the second response, and the third response according to the present embodiment may be achieved by any one of an eyeball motion, a body motion, or an emotional expressive motion using a sound, or a combination thereof.

Furthermore, the motion control unit 150 according to the present embodiment can dynamically determine a motion category related to the first response, the second response, and the third response on the basis of a situation estimated from the sensor information. Note that the situation estimated from the sensor information described above includes various kinds of states/situations related to a user, the autonomous mobile object 10, and the peripheral environment.

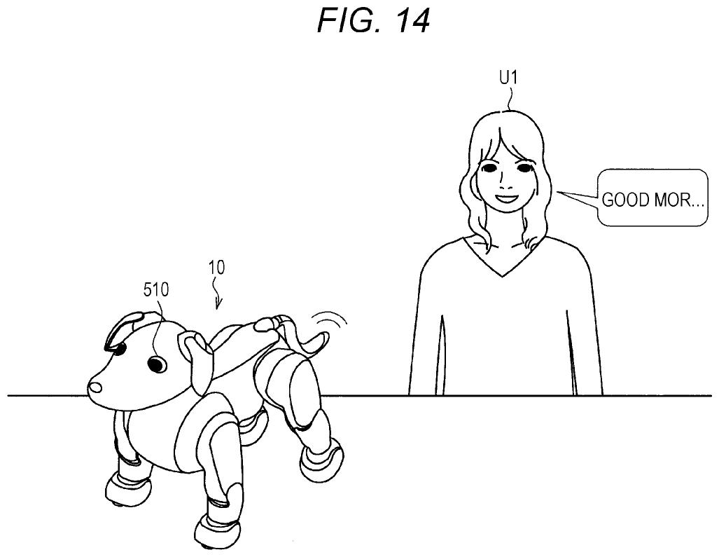

FIG. 14 is a view to describe the dynamic control of a motion category based on a situation according to the present embodiment. FIG. 14 illustrates a situation where a user U1 is issuing an utterance from behind the autonomous mobile object 10. In this case, there is a high possibility that the displays 510 of the autonomous mobile object 10 cannot be recognized from a position of the user U1.

Therefore, in a case where an utterance is detected from behind the autonomous mobile object 10, the motion control unit 150 according to the present embodiment may cause the autonomous mobile object 10 to execute a responding motion not using an eyeball motion, for example, a body motion of wagging the tail, or the like.

Furthermore, for example, in a case where the peripheral environmental sound is loud, the motion control unit 150 may prioritize the eyeball motion or the body motion, and in a situation of having a dark periphery, the motion control unit may prioritize the eyeball motion or the emotional expressive motion using a sound because the body motion can be hardly confirmed.

Furthermore, the motion control unit 150 may dynamically determine, particularly on the basis of a user state, a motion category related to each of the first response, the second response, and the third response. For example, in a case of detecting a fact that a user who usually wears a vision correction tool is not wearing the vision correction tool, the motion control unit 150 does not employ a responding motion using the eyeball motion and may prioritize the emotional expressive motion using a sound.

Furthermore, the similar is applied to a case where a user is estimated to have impaired eyesight. The recognition unit 120 can perform the above-described estimation from, for example, a white cane or the like held by the user. Furthermore, the recognition unit 120 may perform the above-described estimation from a user's reaction in response to an action of the autonomous mobile object 10. Note that the similar is true in terms of a correction device for auditory perception or auditory impairment.

Thus, according to the motion control unit 150 according to the present embodiment, the feedback that is more convenient and responsive to various kinds of situations can be performed.

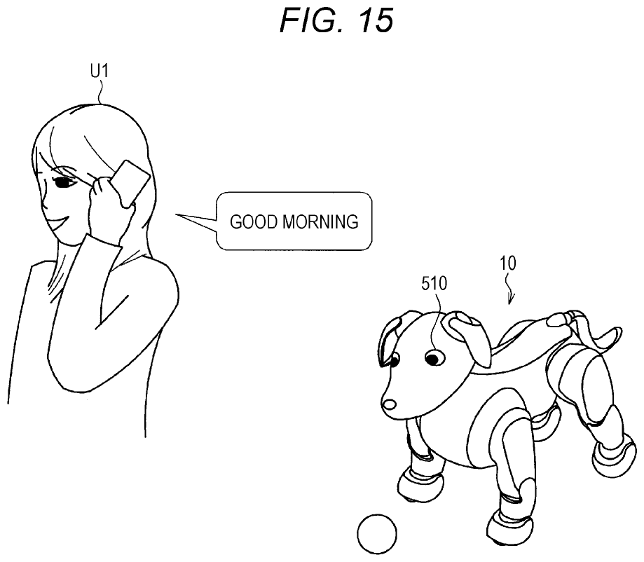

Furthermore, the motion control unit 150 according to the present embodiment may perform motion control based on an addressee of an utterance of a user. FIG. 15 is a view to describe the motion control based on recognition of an addressee of an utterance according to the present embodiment.

FIG. 15 illustrates: a user U1 having a conversation on a telephone; and the autonomous mobile object 10 currently performing an autonomous action. At this time, the motion control unit 150 according to the present embodiment may control execution of any one of the first response, the second response, or the third response, or control such that all of them are not executed, on the basis of a determination that an addressee of an utterance of the user U1 is not the autonomous mobile object 10.

According to the above-described function of the motion control unit 150 according to the present embodiment, a responding motion can be performed only in a case of conforming to an intention of a user, and an effect of improving a user's evaluation on the autonomous mobile object 10 is expected. Furthermore, according to the above-described function, it is possible to suppress power consumption caused by unnecessary motion control.

Note that the recognition unit 120 can determine that the addressee of the utterance of the user is not the autonomous mobile object 10 from a fact that the user is holding the telephone, a line-of-sight of the user is not directed to the autonomous mobile object 10, or the like.

Furthermore, the motion control unit 150 may cause the autonomous mobile object 10 to execute a responding motion until certainty of the determination described above reaches a predetermined level or more. For example, in a case of determining, after execution of the second response, that the addressee of the utterance is not the autonomous mobile object 10, the motion control unit 150 may return to the control of the autonomous action without executing the third response.

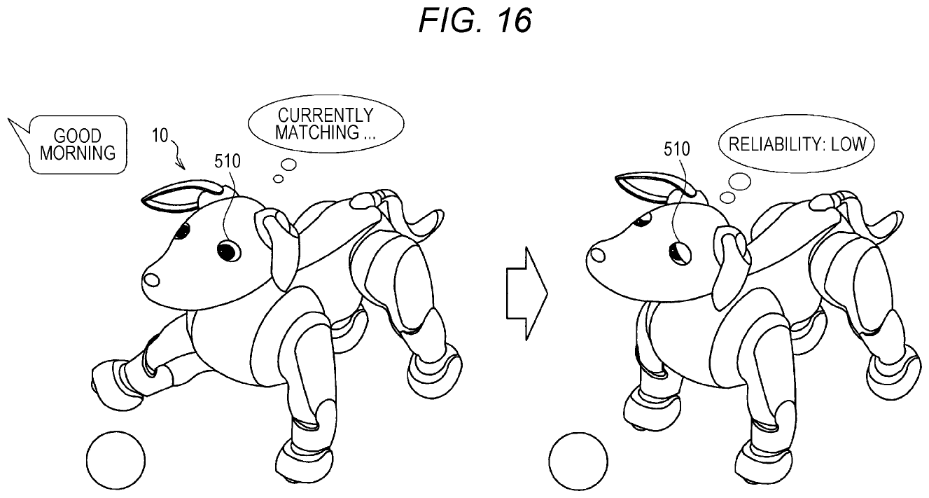

Next, a description will be provided for exemplary motion control in a case of detecting an utterance of a user while the autonomous mobile object is performing some action. FIG. 16 is a view to describe transition control to a responding motion according to the present embodiment. FIG. 16 illustrates an exemplary case of detecting start of an utterance of a user while the autonomous mobile object 10 is playing with a ball.

At this time, the motion control unit 150 according to the present embodiment may gradually stop the action of the autonomous mobile object 10, that is, the action of chasing the ball. Furthermore, the motion control unit 150 performs control such that the autonomous mobile object 10 does not generate any sound after stop of the action.

According to the above-described control by the motion control unit 150, a strange feeling due to the sudden stop of the action is not given to a user, and also degradation in accuracy of voice recognition caused by the driving sound can be prevented by not operating the actuator 570 after the stop.

Note that in a case where the action is not stopped in time and a certainty level of a voice recognition result is degraded due to influence of the driving sound of the actuator 570, the motion control unit 150 causes the autonomous mobile object 10 to execute the third response to prompt an utterance again as illustrated on the right side of FIG. 16, and may control the autonomous mobile object 10 so as not to generate any sound after completion of the third response.

According to the above-described control by the motion control unit 150, the autonomous mobile object 10 is made to execute a more natural motion, and at the same time, it is also possible to improve accuracy related to the voice recognition processing performed again.

In the above, the motion control according to the present embodiment has been described above with the specific examples. According to the function of the motion control unit 150 described above, a more natural motion close to an actual living being can be performed, and at the same time, a user can intuitively grasp progress of the recognition processing by the autonomous mobile object 10.

Note that the case where the autonomous mobile object 10 controls any one of the eyeball motion, the body motion, or the emotional expressive motion using a sound, or a combination thereof has been described above, but the motion control according to the present embodiment can be suitably modified in accordance with characteristics of the recognition processing and the autonomous mobile object 10. For example, in a case where the recognition unit 120 recognizes a contact pattern of a user or the like on the basis of sensor information collected by the touch sensor 540, the motion control unit 150 may cause the autonomous mobile object 10 to execute a responding motion using vibration by a piezoelectric element or the like.

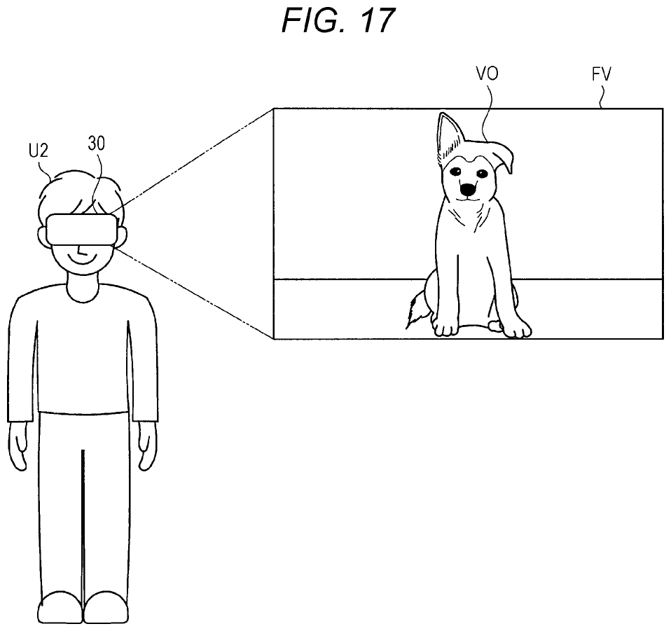

Furthermore, the autonomous mobile object 10 according to the present embodiment may be a moving object in a virtual space (also referred to as a virtual moving object). FIG. 17 is a view to describe control of a virtual moving object according to the present embodiment.

FIG. 17 illustrates a field of view FV of a user U2 wearing an information processing terminal 30, and a virtual moving object VO displayed on the field of view FV. The information processing terminal 30 may be, for example, a head-mounted display or a glasses-type wearable device. At this time, the motion control unit 150 is implemented as a function of the information processing terminal 30 or an information processing server that communicates with the information processing terminal 30. The information processing terminal 30 or the above-described information processing server corresponds to a motion control device described later.

In this case, the motion control unit 150 controls display of the virtual moving object VO using a technology such as augmented reality (AR), virtual reality (VR), mixed reality (MR), or the like.

Here, the virtual moving object VO may include visual information corresponding to a living being like a dog not having a linguistic communication means. According to the above-described control by the motion control unit 150, even in a case where a control target is a virtual object as described above, it is possible to achieve a natural behavior close to an actual living being, and at the same time, it is possible to present feedback related to progress of the recognition processing to a user.

Furthermore, even in a case where the virtual moving object VO is visual information corresponding to a character or the like having a linguistic communication means, a motion closer to reality can be achieved and sense of immersion can be enhanced by: the virtual moving object making a nodding motion when start of an utterance of a user is detected; and the virtual moving object making a thinking motion when the matching is started, for example.

<<3.4. Flow of Control>>

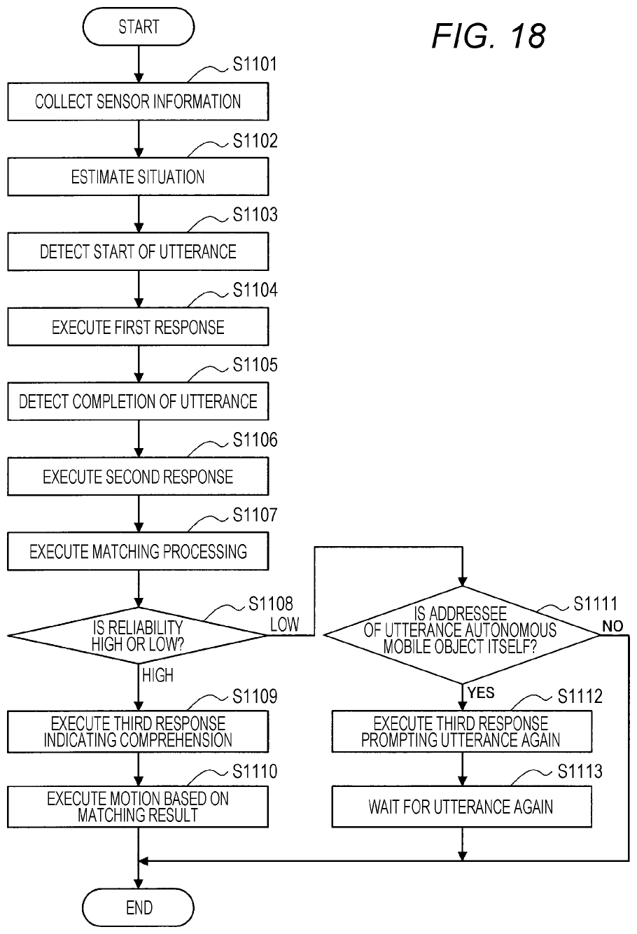

Next, a flow of the motion control according to the present embodiment will be described in detail. FIG. 18 is a flowchart illustrating the flow of the motion control according to the present embodiment.

Referring to FIG. 18, first, the input unit 110 collects sensor information (S1101). The collection of the sensor information in step S1101 is implemented by the various kinds of sensors described in FIG. 1.

Next, the recognition unit 120 estimates a situation on the basis of the sensor information collected in step S1102 (S1102). Note that the collection of the sensor information in step S1101 and the estimation of the situation in step S1102 may be constantly continuously executed.

Next, the recognition unit 120 detects start of an utterance of a user (S1103), and the motion control unit 150 controls execution of a first response (S1104).

Next, the recognition unit 120 detects end of the utterance of the user (S1105), and the motion control unit 150 controls execution of a second response (S1106).

Next, matching processing is executed by the recognition unit 120 (S1107).

Here, in a case where a certainty level related to the matching processing is high (S1108: high), the motion control unit 150 controls execution of a third response indicating comprehension of the utterance (S1109), and also controls execution of a motion based on a matching result (S1110).

On the other hand, in a case where the certainty level related to the matching processing is low (S1108: low), the recognition unit 120 may determine whether or not an addressee of the utterance is the autonomous mobile object 10 (S1111).

Here, in a case where the recognition unit 120 determines that the addressee of the utterance is not the autonomous mobile object 10 (S1111: NO), the motion control unit 150 ends the control related to the responding motion.

On the other hand, in a case where the recognition unit 120 determines that the addressee of the utterance is the autonomous mobile object 10 (S1111: YES), the motion control unit 150 controls execution of the third response that prompts a user to issue the utterance again (S1112), and then causes the autonomous mobile object 10 to wait without generating any sound for the utterance to be issued again (S1113).

<4. Exemplary Hardware Configuration of Motion Control Device>

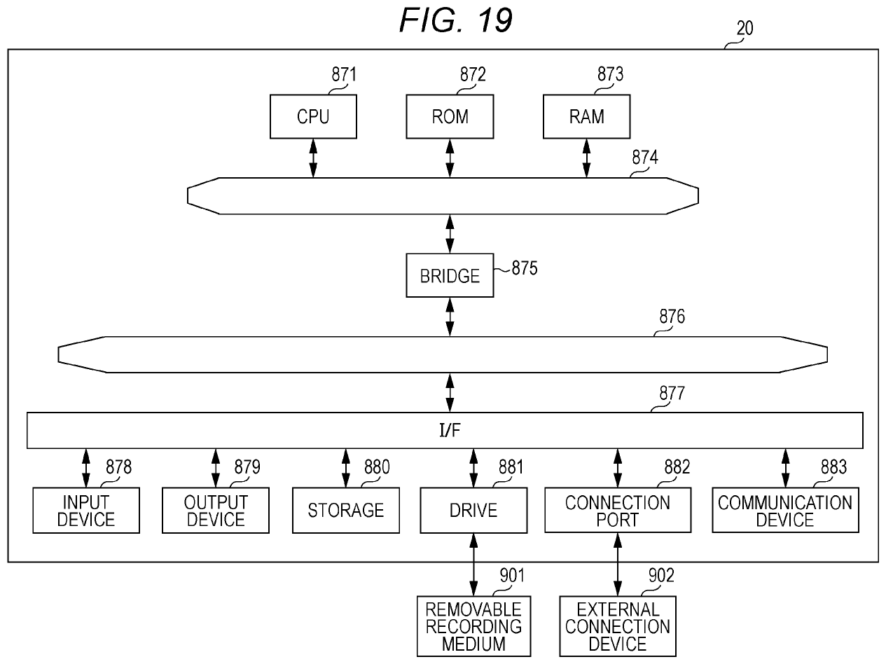

Next, a description will be provided for an exemplary hardware configuration in a case where the function of the motion control unit 150 according to the embodiment of the present disclosure is implemented as a motion control device provided separately from the autonomous mobile object 10. FIG. 19 is a diagram illustrating the exemplary hardware configuration of the motion control device 20 according to the embodiment of the present disclosure. Referring to FIG. 19, the motion control device 20 includes, for example, a CPU 871, a ROM 872, a RAM 873, a host bus 874, a bridge 875, an external bus 876, an interface 877, an input device 878, and an output device 879, a storage 880, a drive 881, a connection port 882, and a communication device 883. Note that the hardware configuration illustrated here is an example, and some of the constituent elements may be omitted. Furthermore, a constituent element other than the constituent elements illustrated here may be further included.

(CPU 871)

The CPU 871 functions as, for example, an arithmetic processing device or a control device, and controls entire or partial operation of the respective constituent elements on the basis of various kinds of programs recorded in the ROM 872, the RAM 873, the storage 880, or a removable recording medium 901.

(ROM 872 and RAM 873)

The ROM 872 is a means that stores: a program read by the CPU 871; data used for calculation; and the like. The RAM 873 temporarily or permanently stores, for example: a program read into the CPU 871; various kinds of parameters that are changed as appropriate at the time of executing the program; and the like.

(Host Bus 874, Bridge 875, External Bus 876, and Interface 877)

The CPU 871, the ROM 872, and the RAM 873 are connected to each other via, for example, the host bus 874 that can perform high-speed data transmission. On the other hand, the host bus 874 is connected to the external bus 876 having a relatively low data transmission speed via the bridge 875, for example. Furthermore, the external bus 876 is connected to various kinds of constituent elements via the interface 877.

(Input Device 878)

As the input device 878, for example, a mouse, a keyboard, a touch panel, a button, a switch, a lever, and the like are used. Furthermore, as the input device 878, a remote controller (hereinafter referred to as a remote controller) capable of transmitting a control signal by using infrared rays or other radio waves may be used. Moreover, the input device 878 includes a voice input device such as a microphone.

(Output Device 879)

The output device 879 is a device capable visually or audibly notifying a user of acquired information, and examples thereof include a display device such as a cathode ray tube (CRT), an LCD, or an organic EL, audio output devices such as a speaker and a headphone, a printer, a mobile phone, a facsimile, and the like. Furthermore, the output device 879 according to the present disclosure includes various kinds of vibration devices capable of outputting tactile stimuli.

(Storage 880)

The storage 880 is a device to store various kinds of data. As the storage 880, for example, a magnetic storage device such as a hard disk drive (HDD), a semiconductor storage device, an optical storage device, a magneto-optical storage device, or the like is used.

(Drive 881)

The drive 881 is a device that reads information recorded on the removable recording medium 901 such as a magnetic disk, an optical disc, a magneto-optical disc, a semiconductor memory, or the like, or writes information onto the removable recording medium 901, for example.

(Removable Recording Medium 901)

Examples of the removable recording medium 901 include, for example, a DVD medium, a Blu-ray (registered trademark) medium, an HD/DVD medium, various kinds of semiconductor storage media, and the like. Needless to mention that the removable recording medium 901 may be, for example, an IC card on which a non-contact IC chip is mounted, an electronic device, or the like.

(Connection Port 882)

The connection port 882 is, for example, a port to connect an external connection device 902 such as a universal serial bus (USB) port, an IEEE 1394 port, a small computer system interface (SCSI), an RS-232C port, or an optical audio terminal.

(External Connection Device 902)

The external connection device 902 is, for example, a printer, a portable music player, a digital camera, a digital video camera, an IC recorder, or the like.

(Communication Device 883)

The communication device 883 is a communication device to be used for connection to a network, and an example thereof is a communication card for wired or wireless LAN, Bluetooth (registered trademark) or a wireless USB (WUSB), a router for optical communication, a router for an asymmetric digital subscriber line (ADSL), various kinds of communication modems, or the like.

<5. Conclusion>

As described above, the autonomous mobile object 10 that implements the information processing method according to the embodiment series of the present disclosure has one of the features of executing, on the basis of input of the recognition target information, a responding motion that is the implicit feedback related to the execution of the recognition processing. According to such a configuration, the feedback related to the execution of recognition processing can be achieved with a more natural motion.

While the preferred embodiments of the present disclosure have been described in detail with reference to the attached drawings, the technical scope of the present disclosure is not limited to the examples. It is obvious that a person having ordinary skill in the technical field of the present disclosure can readily conceive various modified examples or various revised examples within the scope of the technical idea described in the claims, and it should be understood that these modified and revised examples are also included in the technical scope of the present disclosure.

Furthermore, the effects described in the present specification are merely illustrative or exemplary and are not limitative. In other words, the technology according to the present disclosure can provide other effects that are apparent to those skilled in the art from the description of the present specification in addition to or instead of the above-described effects.

Furthermore, the respective steps related to the processing of the autonomous mobile object 10 in the present specification may not necessarily be processed in time series in accordance with the sequence described in the flowchart. For example, the respective steps related to the processing of the autonomous mobile object 10 may be processed in a sequence different from the sequence described in the flowchart, or may be processed in parallel.

Note that the following configurations are also included in the technical scope of the present disclosure.

(1)

An information processing device including a motion control unit that performs motion control of a moving object that acts on the basis of recognition processing, in which

the motion control unit causes the moving object to execute a responding motion on the basis of input of recognition target information, and

the responding motion is implicit feedback related to execution of the recognition processing.

(2)

The information processing device recited in (1) described above, in which

the motion control unit causes the moving object to execute a first response on the basis of a fact that start of input of the recognition target information is detected, and causes the moving object to execute a second response on the basis of a fact that completion of the input of the recognition target information is detected, and

the first response and the second response are the implicit feedback related to execution of the recognition processing.

(3)

The information processing device recited in (2) described above, in which

the motion control unit causes the moving object to execute, on the basis of a fact that the recognition processing is completed, a third response that is feedback related to execution of the recognition processing.

(4)

The information processing device recited in (3) described above, in which

the motion control unit causes the moving object to execute an action based on the recognition processing after execution of the third response.

(5)

The information processing device recited in (3) or (4) described above, in which

the moving object has a form and ability replicating a living being, and

the first response, the second response, and the third response include any one of a body motion, an eyeball motion, an emotional expressive motion using a sound.

(6)

The information processing device recited in any one of (3) to (5) described above, in which

the motion control unit dynamically determines a motion category related to each of the first response, the second response, and the third response on the basis of a situation estimated from sensor information.

(7) The information processing device recited in any one of (3) to (6) described above, in which

the motion control unit dynamically determines a motion category related to each of the first response, the second response, and the third response on the basis of a state of a user.

(8)

The information processing device recited in any one of (3) to (7) described above, in which

the motion control unit dynamically determines a motion of the third response on the basis of reliability related to the recognition processing.

(9) The information processing device recited in any one of (3) to (8) described above, in which

the recognition processing is voice recognition processing.

(10) The information processing device recited in (9) described above, in which

the first response is an eyeball motion.

(11)

The information processing device recited in (9) or (10) described above, in which

the moving object is a device having a drive unit.

(12)

The information processing device recited in any one of (9) to (11) described above, in which

the motion control unit does not cause the moving object to execute at least one of the first response, the second response, or the third response on the basis of a determination that an addressee of an utterance of a user is not the moving object.

(13)

The information processing device recited in any one of (9) to (12) described above, in which

in a case where start of an utterance of a user is detected during an action of the moving object, the motion control unit gradually stops the action.

(14)

The information processing device recited in (13) described above, in which

the motion control unit controls the moving object not to generate any sound after stopping the action.

(15)

The information processing device recited in any one of (9) to (14) described above, in which

in a case where reliability related to the voice recognition processing is low, the motion control unit causes the moving object to execute the third response that prompts a user to issue an utterance again.

(16)

The information processing device recited in (15) described above, in which

the motion control unit controls the moving object not to generate any sound after completion of the third response that prompts the utterance again.

(17)

The information processing device recited in any one of (1) to (6) described above, in which

the moving object is an autonomous mobile object having no linguistic communication means.

(18)

The information processing device recited in any one of (1) to (17), in which

the information processing device is the moving object.

(19)

An information processing method including performing, by a processor, motion control of a moving object that acts on the basis of recognition processing, in which

performing the motion control further includes

causing the moving object to execute a responding motion on the basis of input of recognition target information, and

the responding motion is implicit feedback related to execution of the recognition processing.

(20)

A program causing a computer to function as an information processing device including

a motion control unit that performs motion control of a moving object that acts on the basis of recognition processing, in which

the motion control unit causes the moving object to execute a responding motion on the basis of input of recognition target information, and

the responding motion is implicit feedback related to execution of the recognition processing.

### REFERENCE SIGNS LIST

10 Autonomous mobile object

110 Input unit

120 Recognition unit

130 Learning unit

140 Action planning unit

150 Motion control unit

160 Drive unit

170 Output unit

510 Display

570 Actuator cm 1. An information processing device comprising
a motion control unit configured to perform motion control of a moving object that acts on a basis of recognition processing, wherein
the motion control unit causes the moving object to execute a responding motion on a basis of input of recognition target information, and
the responding motion includes implicit feedback related to execution of the recognition processing.

2. The information processing device according to claim 1, wherein
the motion control unit causes the moving object to execute a first response on a basis of a fact that start of input of the recognition target information is detected, and causes the moving object to execute a second response on a basis of a fact that completion of the input of the recognition target information is detected, and
the first response and the second response are the implicit feedback related to execution of the recognition processing.

3. The information processing device according to claim 2, wherein
the motion control unit causes the moving object to execute, on a basis of a fact that the recognition processing is completed, a third response that is feedback related to execution of the recognition processing.

4. The information processing device according to claim 3, wherein
the motion control unit causes the moving object to execute an action based on the recognition processing after execution of the third response.

5. The information processing device according to claim 3, wherein
the moving object has a form and ability replicating a living being, and
the first response, the second response, and the third response include any one of a body motion, an eyeball motion, an emotional expressive motion using a sound.

6. The information processing device according to claim 3, wherein
the motion control unit dynamically determines a motion category related to each of the first response, the second response, and the third response on a basis of a situation estimated from sensor information.

7. The information processing device according to claim 3, wherein
the motion control unit dynamically determines a motion category related to each of the first response, the second response, and the third response on a basis of a state of a user.

8. The information processing device according to claim 3, wherein
the motion control unit dynamically determines a motion of the third response on a basis of reliability related to the recognition processing.

9. The information processing device according to claim 3, wherein
the recognition processing is voice recognition processing.

10. The information processing device according to claim 9, wherein
the first response is an eyeball motion.

11. The information processing device according to claim 9, wherein
the moving object is a device having a drive unit.

12. The information processing device according to claim 9, wherein
the motion control unit does not cause the moving object to execute at least one of the first response, the second response, or the third response on a basis of a determination that an addressee of an utterance of a user is not the moving object.

13. The information processing device according to claim 9, wherein
in a case where start of an utterance of a user is detected during an action of the moving object, the motion control unit gradually stops the action.

14. The information processing device according to claim 13, wherein
the motion control unit controls the moving object not to generate any sound after stopping the action.

15. The information processing device according to claim 9, wherein
in a case where reliability related to the voice recognition processing is low, the motion control unit causes the moving object to execute the third response that prompts a user to issue an utterance again.

16. The information processing device according to claim 15, wherein
the motion control unit controls the moving object not to generate any sound after completion of the third response that prompts the utterance again.

17. The information processing device according to claim 1, wherein
the moving object is an autonomous mobile object having no linguistic communication means.

18. The information processing device according to claim 1, in which
the information processing device is the moving object.

19. An information processing method comprising
performing, by a processor, motion control of a moving object that acts on a basis of recognition processing, wherein
performing the motion control further includes
causing the moving object to execute a responding motion on a basis of input of recognition target information, and
the responding motion is implicit feedback related to execution of the recognition processing.

20. A program causing a computer to function as an information processing device including
a motion control unit configured to perform motion control of a moving object that acts on a basis of recognition processing, wherein
the motion control unit causes the moving object to execute a responding motion on a basis of input of recognition target information, and
the responding motion is implicit feedback related to execution of the recognition processing.
